(19) United States
(12) Patent Application Publication
(10) Pub. No.: US 2013/0159254 A1
(43) Pub. Date: Jun. 20, 2013

(54) SYSTEM AND METHODS FOR PROVIDING CONTENT VIA THE INTERNET

(71) Applicants: Wen-Yen Chen, San Jose, CA (US); Zhichen Xu, San Jose, CA (US)

(72) Inventors: Wen-Yen Chen, San Jose, CA (US); Zhichen Xu, San Jose, CA (US)

(73) Assignee: YAHOO! INC., Sunnyvale, CA (US)

(21) Appl. No.: 13/325,121

(22) Filed: Dec. 14, 2011

(51) Int. Cl. G06F 17/30; G06F 7/00

(52) U.S. Cl. 707/639; 707/736; 707/754; 707/776; 707/E17.014; 707/E17.005

(57) ABSTRACT

Systems and methods to enhance enhancing a service for a user. The system collecting documents viewed or words posted by a user. Determining a list of topic words for the user based on words in the documents viewed or words posted. Identifying a list of topic words associated with the user, based on words in the one or more documents and the words posted by the user. Assigning each of the topic words to at least one of a plurality of topics based on correlations between the topic words of the user and topic words from other users. Estimating a set of interest topics for the user based on the topics assigned to the topic words of the user.

### BACKGROUND

1. Technical Field

The teaching relates generally to providing content via the Internet. More particularly, the teaching relates to providing customized content via the Internet.

2. Discussion of Technical Background

Service providers such as social networking sites and news sites on the Internet attract hundreds of millions of users every month. The popularity of such a service provider depends on many factors. A factor is the ease-of-use of the service provider, which corresponds to the ability of a user to navigate the service provider's content, and find information and content relevant to the user. Another factor is the ability of the service provider to present or suggest content relevant to the user that the user did not search for but nevertheless is interested in.

To aid users, companies and advertisers attempt to predict the interests of users. These predictions are used to place targeted advertisements in front of users, and aid users of the service providers. The better the predictions of the interests of the users, the better will be the aid and advertisements provided to users by the service providers. Thus, users will have a better experience of the service provider, and the service provider will become more popular generating more revenue. Poor predictions of the interests of the users cause frustration to the users and may cause the users to visit a different service provider. The popularity of a service provider on the Internet often leads to an increase in the number of users, which usually translates into a higher revenue. The more users a service provider attracts, the more potential the service provider can provide improved revenues to its operator.

### SUMMARY

The teaching disclosed herein relates to methods, systems, and programming for providing content via the Internet. More particularly, the present teaching relates to methods, systems, and programming for providing customized content via the Internet.

In one example, a method implemented on a machine having at least one processor, storage, and a communication platform connected to a network for enhancing a service for a user. One or more documents viewed by the user or words posted by the user are collected, is disclosed. A list of topic words associated with the user based on words in the one or more documents and the words posted by the user are identified. Each of the topic words is assigned to at least one of a plurality of topics, based on correlations between the topic words of the user and topic words from other users. A set of interest topics for the user is estimated, based on the topics assigned to the topic words of the user.

In another example, a method, implemented on a machine having at least one processor, storage, and a communication platform connected to a network for enhancing a service for a user, is disclosed. Documents viewed or words posted by the user are received via the communication platform. A list of topic words for the user based on words in the documents and words posted by the user is determined. A likelihood that each user is interested in one of a plurality of topics is calculated, based on correlations between the topic words for the user and topic words for other users. A list of unique words is determined from the list of the topic words for the user and the topic words in lists of topic words for the other users. A likelihood is calculated that each unique word belongs to each of the number of topics based on correlations between the topic words for the user and the topic words in lists of topic words for the other users.

In a different example, a system for enhancing a service for a user comprising a server, a first database, a second database, a topic mining engine and a third database, is disclosed. The server delivers the service to the user. The first database is coupled to the server and stores preferences or declared interests of the user. The second database is coupled to the server and stores information regarding documents viewed by or words posted by the user. The topic mining engine estimates interest topics of the user based on correlations between a use by the user of topic words in the documents viewed by or posted the user and a use of the topic words by other users. The third database stores the interest topics of the user estimated by the topic mining engine, wherein the server delivers the service to the user based on data in the third database associated with the user.

Other concepts relate to software for implementing the generation of explanations for relationships. A software product, in accord with this concept, includes at least one machine-readable non-transitory medium and information carried by the medium. The information carried by the medium may be executable program code data regarding parameters in association with a request or operational parameters, such as information related to a user, a request, or a social group, etc.

In yet another example, a machine-readable tangible and non-transitory medium having information recorded thereon, wherein the information, when read by a machine, causes the machine to perform a method of enhancing a service for a user, is disclosed. Documents viewed or words posted by the user are collected, via a communication platform. A list of topic words for the user is determined based on words in the documents viewed or words posted by the user. Each of the topic words is assigned to at least one of a plurality of topics based on correlations between topic words of the user and topic words of other users. A set of interest topics for the user is estimated, based on the topics assigned to the topic words of the user.

Additional advantages and novel features will be set forth in part in the description that follows, and in part will become apparent to those skilled in the art upon examination of the following and the accompanying drawings or may be learned by production or operation of the examples. The advantages of the present teaching may be realized and attained by practice or use of various aspects of the methodologies, instrumentalities and combinations set forth in the detailed examples discussed below.

### BRIEF DESCRIPTION OF THE DRAWINGS

The methods, systems, and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIGS. 1A-1C illustrate systems for performing analysis to determine both explicit and underlying topics that users of service providers are interested in according to an embodiment;

FIGS. 2A-2C illustrate a method of performing analysis to determine both explicit and underlying topics that users of a service providers are interested in according to an embodiment;

FIG. 3 illustrates a method of webpage customization according to an embodiment;

FIG. 4 illustrates the topic model used to assign the topic words to topics using plate notation according to an embodiment;

FIG. 5 illustrates a method for approximating the assignment of words to topics based on Gibbs sampling according to an embodiment;

FIG. 6 illustrates an example of the resulting output, of approximating the assignment of words to topics based on Gibbs sampling for two users; and

FIG. 7 depicts a general computer architecture on which the present teaching can be implemented.

### DETAILED DESCRIPTION

Internet service providers desire the ability to track users as they navigate content provided by the service provider. This tracking may be performed based on a variety of means. For example, tracking may be performed based on the activities of a user if the user is registered with a service provider. As another example, the tracking can also be done based on cookies passed between the service provider and a web browser. User information may also be obtained via a third party service provider whose service is to track users' activities and gather information about users. The user information gathered via different means may enable a service provider to improve the content provided by the service provider. For example, the gathered user information may allow the service provider to simplify commonly performed actions of the user on the site by pre-filling fields in forms. The tracking also allows the service provider to utilize information associated with selections and actions performed by the user and customize content base on those selections and actions.

Service providers often attempt to gather as much information as possible, for example, during user registration. Using information obtained during the registration process, the service provider is able to customize the content provided to meet the user's needs. The personal data entered can often be used to predict the interests of the user. For example, the age of the user allows the service provider to categorize the user into a particular demographic. Based on IP addresses and Internet providers for the user, the service provider can determine the approximate geographic location of the user. The user may input an address, telephone number, e-mail address, relationships to other users, relationships to schools, work places and other institutions during the registration process. The service provider can also track the interests of users by, for example, tracking links on a webpage that a user clicks, and the known topics that those links correspond with.

Quite often, user's interests can be identified via topics identifiable from web pages they viewed. For example, a user may click on a link about a news article regarding pets. Although, the service provider knows that the user is interested in pets, the service provider cannot determine whether the user is interested in, e.g., in particular, cats. The user may have clicked on other articles that have cats as a topic, for example, an article about the decline of garden birds, but unless the user clicks on a link that is specific to cats, the service provider cannot determine that the user's interest is primarily cats.

Furthermore, new topics may arise for which there are no articles or links to click. For example, the term “smart phone” was not in general use until, e.g., year 2009. However, many phones that had features similar to today's smart phone features existed in the past. Thus, the topic of smart phones may exist in the past record without expressly mentioning the term “smart phones.” Therefore, no link with the term smart phone existed, but users on the Internet may still desire to search for information related to phones that have such features. Moreover, following the clicks of one user at service providers over a period of time may not provide enough information to specifically identify topics that the user is interested in.

If there are a large number of users of the service provider, the actions of these users can be used to improve the granularity and fidelity of the identification of topics that each user is interested in. Any particular user may be associated with a finite number of topics that he/she is primarily interested in. The primary interests of one user may differ from other users, but may also overlap with some users. The different and overlapping interests between users allow underlying topics to be identified, and allow known topics to be refined when the web page is presented to each particular user. For example, a first user may be interested in cats, dogs, and fish. A second user might be interested in cats, horses and birds, and a third user may be interested in cats, frogs, and snakes. None of the above three users may ever click on a website link that specifically has cats as a topic, however, a human reader looking at all of the documents clicked by all three users might quickly see that the topic of cats occurs frequently. The human reader may also note that there are some documents clicked by all three users that have cats as a topic, but do not have dogs, fish, horses, birds, frogs, or snakes as a topic. Based on these observations, a human reader would judge it likely that all three users are interested in cats. Service providers, however, have millions of users looking at millions of documents and links, therefore, there will be many users that share interests, and many users that do not share interests. It is impractical for a human reader to sort through all of the documents and links clicked by all of the users to look for underlying topics that interest some of the users. However, for a machine the process is not, given suitable techniques to process all of the documents.

Thus, by assuming that individual users are interested in a finite number of topics, it is possible to find underlying topics of interest of each user. These topics can be identified even if it is not apparent from any of the articles the users have read, which underlying topics the articles are explicitly directed to. In some embodiments, such underlying topics can be identified via correlations between words used in articles read or contributed by users, given the assumption that the words in the articles belong to one of a number of topics. The words are assigned to the topics so as to “minimize” the number of topics each word is assigned to, and at the same time, “minimize” the number of topics each user is assigned to. Based on the assignments, the underlying topics can be identified.

In some embodiments, this can be achieved based on Bayesian inference. Given a particular allocation of words used by each user to the topics, the probability that the allocation is accurate can be compared with other possible allocations using variational Bayesian methods. These variational Bayesian methods produce more accurate results if more data is available. Thus, the method works better with larger number of users performing larger numbers of activities at the service provider. Therefore, a larger website using this technique will be able to discern the interests of the users with greater accuracy and fidelity than a smaller website with fewer users.

In some embodiments, the above process for identifying underlying topics and users' interests could be offered as a service by a service provider to a number of other service providers. These other service providers can then pool their combined user activities to discern the interests of the users with greater accuracy and fidelity. In some embodiments, the above process for finding underlying topics and the interests of users could be deployed as a backend support for any particular service provider.

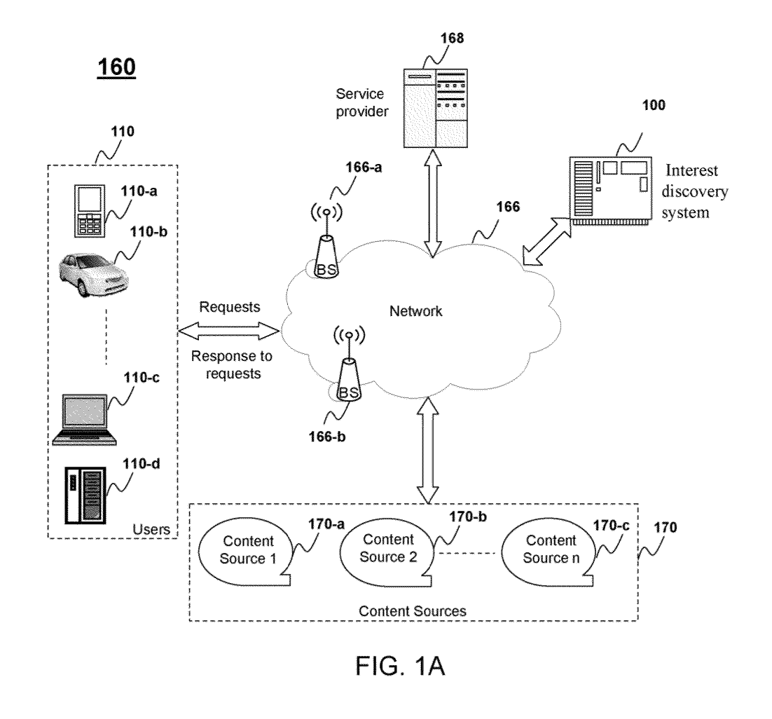

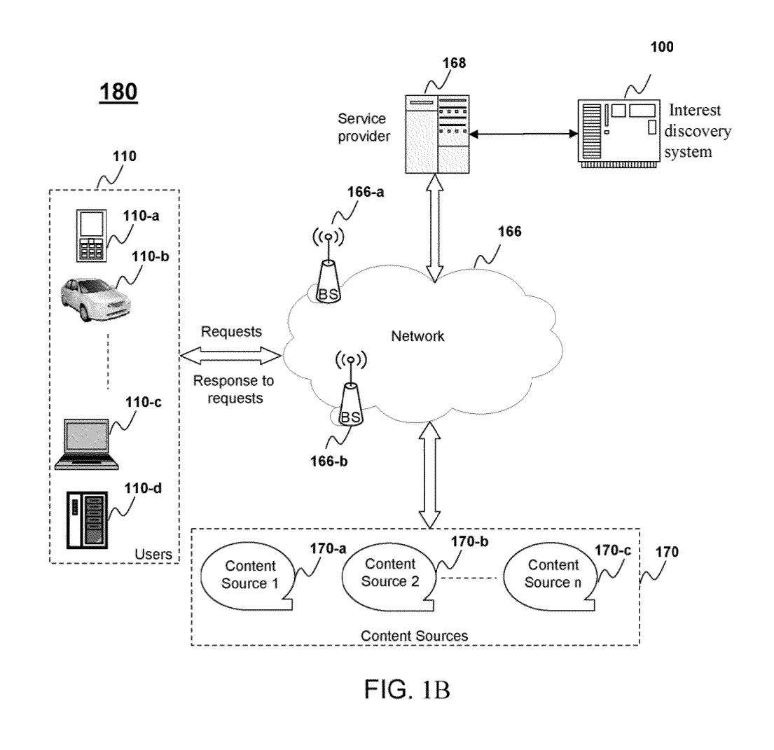

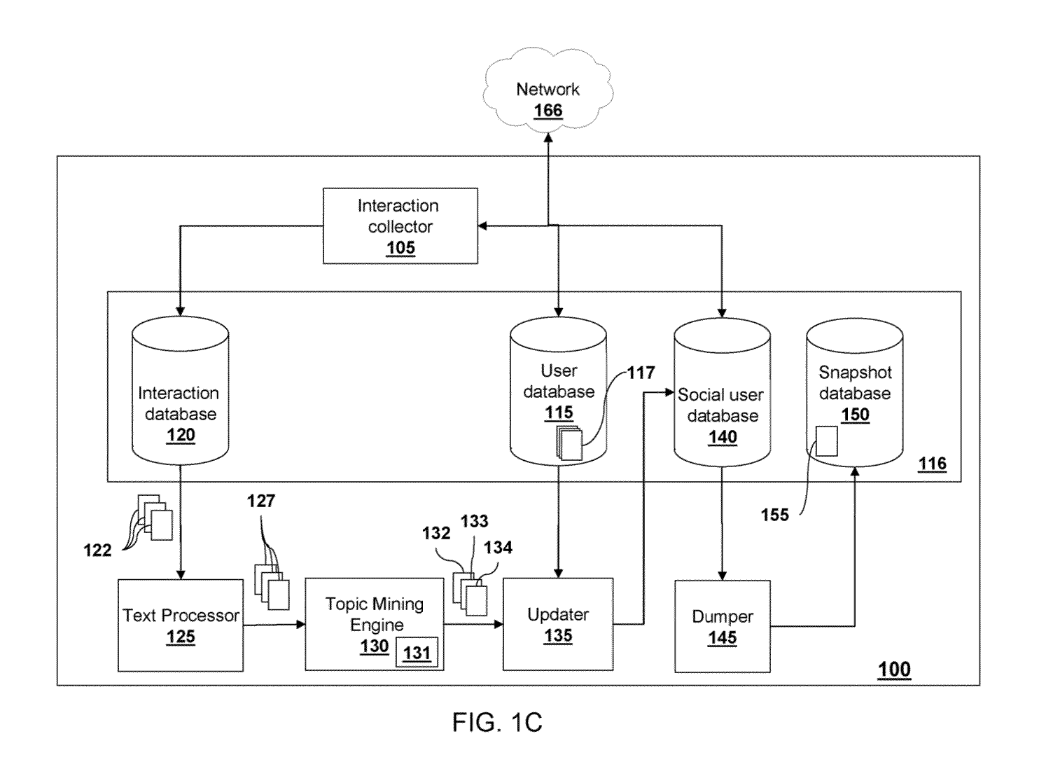

FIG. 1A is a high level depiction of an exemplary system 160, in which an interest discovery system 100 for performing analysis to determine both explicit and underlying interest topics of users is deployed, according to a first application embodiment of the present teaching. The exemplary system 160 includes users 110, a network 166, a service provider 168, content sources 170, and the interest discovery system 100 for performing analysis to determine both explicit and underlying topics of users. The network 166 in system 160 can be a single network or a combination of different networks. For example, a network can be a local area network (LAN), a wide area network (WAN), a public network, a private network, a proprietary network, a Public Telephone Switched Network (PSTN), the Internet, a wireless network, a virtual network, or any combination thereof. A network may also include various network access points, e.g., wired or wireless access points such as base stations or Internet exchange points 166-a, . . . , 166-b. Using the wired or wireless access points, a data source may connect to the network in order to transmit information via the network.

Users 110 may be of different types such as users connected to the network via desktop connections (110-d), users connecting to the network via wireless connections such as through a laptop (110-c), a handheld device (110-a), or a built-in device in a motor vehicle (110-b). A user may send a request to the service provider 168 via the network 166 and receive a request result from the service provider 168 through the network 166. The request result may be provided directly by the service provider 168 or obtained by the service provider 168 from any one of a number of content sources 170. The content sources 170 include multiple content sources 170-a, 170-b, . . . , 170-c. A content source may correspond to a web page host corresponding to an entity. The web page host may be an individual, a business, or an organization such as USPTO.gov, a content provider such as cnn.com and Yahoo.com, or a content feed source such as tweeter or blogs. The requests and request results are also sent to the network 166 and are directed to the interest discovery system 100. The interest discovery system 100 performs analysis to determine both explicit and underlying topics of users. Both the service provider 168 and the interest discovery system 100 may access information from any of the content sources 170-a, 170-b, . . . 170-c. The service provider 168 may rely on such information to respond to a request (e.g., the service provider 168 provides web content corresponding to the request and returns the web content to a user). The interest discovery system 100 may rely on content sources 170-a, 170-b, . . . 170-c to collect interactions of users with information available on the network 166.

In the exemplary system 160, a user may initially send a request for a web page to the service provider 168. The request, and the response for the request, are sent to the interest discovery system 100. As discussed above, based on correlations between words viewed or posted by each user the interest discovery system 100 finds the topics of interest to each user, and the words associated with each topic. This allows users and entities to query the interest discovery system 100 to find topics of interest to users, and words that correspond to the topics. Further, this allows users and entities to query the interest discovery system 100 to find the topics that any particular user is interested in.

FIG. 1B is a high level depiction of an exemplary system 180, in which an interest discovery system 100 for performing analysis to determine both explicit and underlying interest topics of users is deployed. The interest discovery system 100 in FIG. 1A is connected to the network 166. In FIG. 1B the interest discovery system 100 is directly connected to service provider 168. The service provider 168 forwards the requests, and responses to the requests to the interest discovery system 100. To identify topics of interest of users, the service provider 168 queries the interest discovery system 100.

FIG. 1C illustrates the interest discovery system 100 for performing analysis to determine both explicit and underlying topics in which users 110 are interested.

The interest discovery system 100 comprises an interaction collector 105, interaction database 120, a user database 115, a text processor 125, a topic mining engine 130, an updater 135, a social user database 140, a dumper 145, and a snapshot database 150.

In some embodiments, the user database 115, the interaction database 120, the social user database 140, and the snapshot database 150, are separate databases. In some embodiments, the user database 115, the interaction database 120, the social user database 140, and the snapshot database 150, are portions of a database or database system 116.

The interaction collector 105 may be connected to the users 110 and service provider 168 by a network 166 such as the Internet, a local area network, a wireless network such as a Wi-Fi or cell phone network, or any combination of the above. The interaction collector 105 collects the interactions of users 110 including, for example, serving of web pages from websites, downloads, RSS feeds, e-mail, instant messaging, web applications such as text editors, website building software, e-mail applications, text messaging applications, social networking applications and any other applications compatible with embodiments of this disclosure. The interactions of users may be forwarded by service provider 168.

The user database 115 contains the core information about each user 110. The core information may be provided by service provider 168. The user database 115 contains, for example, the name of each user 110, contact information for each user 110, authentication information for each user 110, gender for each user 110, citizenship of each user 110, date of birth of each user 110, career professional or job of each user 110, and interests explicitly declared by each user 110. For example, many websites allow users 110 to select areas of interest, hobbies, favorite music, favorite books, most admired people etc. so that other users 110 can search and find people with similar interests. In addition, the user database may contain explicit information known about the user 110 due to the normal interactions of the user with the service provider. For example, the user 110, during normal use, may be able request the service provider to customize content and style of web pages that the user 110 receives from the service provider. Many websites, for example, allow users 110 to select the items that appear on a personal webpage to reflect the user's interests. The selection may be, for example, information such as weather, type of news, websites of friends etc. The user 110 can select from lists of such items, which items appear on which personal web pages. The user 110 may also be able to select the position on a personal webpage for the selected information. The selections of items to appear on the personal webpage and the positions of these items are examples of information stored in the user database 115. The selections of items to appear on the personal webpage also provide information regarding the interests of the user 110. It can be assumed that the user 110 is likely interested in material in the items selected to appear on the user's personal webpage. Therefore, based on how the user 110 customizes any personal web pages, the user database 115 is updated with interests of the user 110 by the service provider 168.

The user database 115 may also contain, for example, address books or contact lists of users 110 of service provider 168, forwarded by the service provider 168. It can be inferred that the interests of the user 110 are likely similar to the interests of people on the user's contact list. If the contact list contains the contacts for other users 110 of the service provider 168, information from the database regarding the other users 110 of the service provider 168 can be used to further infer the interests of the user 110. The user database 115 is connected to the network 166. The service providers store the above data in the user database 115 based on actions performed by the users 110 at the service provider 168. The above information in the user database 115 constitutes declared interests 117 that can be used by the service provider 168 to customize content for the users 110.

The interaction database 120 contains information regarding the activity of a user 110 with the service provider 168. The interaction database 120 is connected to the interaction collector 105. As the user 110 interacts with the service provider 168, the service provider 168 forwards the interactions of the user via the network 166 to the interaction collector 105. The interaction collector 105 records interactions of the user 110 in the interaction database 120. The interaction database 120 contains, for example, Internet links clicked when the user 110 visits the service provider 168, the time spent visiting any links clicked, the frequency that any given link is clicked by the user 110, and the times of day that the user 110 visits the service provider 168. The user 110 may also post information to various parts of the service provider 168, for example, as blogs or comments to articles at the service provider 168. Further, the user 110 may have an e-mail account, instant message account, Twitter account, Facebook account, or may send text messages to cell phones using the service provider 168. Text and information contained in received or sent information from these accounts may be saved in the interaction database 120. Thus, after a period of use of the service provider 168 by the user 110, a considerable quantity of data regarding the use of any information sent by and received by the user 110 is gathered in interaction database 120. Interaction database 120, therefore, contains a large amount of data indicating topics that the user 110 may be interested in. However, unlike the information contained in the user database 115 the data contained in the interaction database 120 is not in a form that is readily converted into information regarding topics of interest to the user 110. To become useful the information in the interaction database 120 needs to be processed to extract useful information about the users' interests.

Some information regarding the user's interests can be obtained merely by observing words frequently used by or read by the user 110. Some words such as, for example, proper nouns have such specific and unique meanings that there is no doubt about the interests of the user 110. Most words used by the user 110, however, do not fall into this category, but the topic that the word refers to can be understood by using the context in which the word is used. It is possible to construct a system that is somewhat capable of refining topics referred to by the user 110 by considering the relationship between various words used by the user 110. However, such a system would have to be constructed and custom built and is not capable of adapting to different users 110 or to a change of language use.

The text processor 125 is connected to the interaction database 120. The text processor 125 receives the information stored in the interaction database 120 in the form of files and documents 122. The files and documents 122 comprise e-mail files, text message files, webpage files, image files etc. The text processor 125 filters the various files received from the interaction database 120 to extract topic words 127. The topic words 127 are extracted into a single file for each user 110. The topic words 127 comprise words that likely indicate a topic being read or written about by a user 110. Words that are filtered by the text processor 125 include words that are unlikely to indicate the topic being read or written about by a user 110. One group of words removed by the text processor 125 include words and symbols relating to formatting of text or web pages, for example, HTML tags, XML tags, web page addresses, and Rich Text File formatting information. A second group of words removed by the text processor 125 includes punctuation symbols such as “.,;:?!” A third group of words removed by the text processor 125 includes stop words such as the, a, an, which, and that. The text processor 125 may also remove verbs, adjectives, and prepositions.

In some embodiments, the text processor 125 may also count occurrences of a particular topic word 127 extracted by the above filtering across all users 110. In those embodiments, the text processor 125 may remove particular topic words that have a number of occurrences below a predetermined threshold. For example, topic words 127 that occur only once among all of the users 110 may not be useful for defining a topic because such words cannot be correlated with any other words of any other users 110.

The interest discovery system 100 further comprises a topic mining engine 130. The topic mining engine 130 is connected to the text processor 125 and receives the topic words 127 from the text processor 125. The topic mining engine 130 performs various functions. The first function performed by the topic mining engine 130 is assigning the topic words 127 of each user 110 to a particular topic based on the correlation between words used by each user 110. As a second function, the topic mining engine 130 generates a lexicon 131 that contains one occurrence of each unique word among all of the topic words of all users 110. Once all words are assigned to a particular topic and the lexicon 131 is complete, the topic mining engine 130 performs a third function of calculating the probability that each user 110 is interested in each topic by, for example, summing the number of topic words 127 assigned to each topic for that user 110. Further, the topic mining engine 130 performs a fourth function of calculating the probability that any particular word in the lexicon 131 refers to a particular topic 132 by, for example, summing the number of topic words 127 assigned to that topic 132 across all users 110. The topic mining engine 130 outputs the probabilities 133 of users 110 being interested in topics, and the probabilities 134 of words in the lexicon being assigned to a topic. The topic mining engine 130 outputs the topics 132, the lexicon 131, and the probabilities 133, 134 to an updater 135.

The updater 135 combines the probabilities 133, 134 provided by the topic mining engine 130 with the declared interests 117 and information from the user database 115 to a social user database 140. The updater 135 may also update the social user database 140 if the information stored in the interaction database 120 changes. If the information stored in the interaction database 120 changes then the processes performed by the text processor 125 and the data topic milling engine 130 are re-executed before the updater 135 updates the social user database 140.

The social user database 140 can be used in various ways. For example, the social user database can be queried to find all users 110 interested in a particular topic 132. Based on such a query, an e-mail or some other form of message regarding information about the topic 132 could be sent to each of the users 110 interested in that topic 132. Alternatively, the social user database can be queried to find the interests of a particular user 110. Based on such a query, advertising may be incorporated into web pages requested by the user 110. In yet another example, topics 132 associated with particular topic words can be queried. Thus, for example, by querying the word “fashion” an emerging retailer, designer, or new fashion type might be observed emerging based on chat room discussions and e-mails.

The social user database 140 may be continuously updated by the topic mining engine 130 and the user database 115. Further, the social user database 140 may be continuously updated by any other sources with relevant information about either users 110 or topics 132 that the users 110 might be interested in. The social user database 140 may be continuously accessed by various applications and users such as the service provider 168 or e-mail servers (not shown) to customize and send users 110 information about topics 132 that users 110 may be interested in.

The interest discovery system 100 further comprises a dumper 145. The dumper 145 is connected to the social user database 140. The dumper 145 allows a snapshot 155 of the social user database 140 to be taken at a specific time and stored in the snapshot database 150. The social user database 140 may be extremely large. If data processing is to be performed on the social user database 140 requiring a large portion of the social user database 140 to be read, then such data processing is better performed on a snapshot of the social user database 140. A snapshot is also useful if the data processing takes considerable time between reading portions of the social user database 140. In some embodiments, the dumper 145 freezes the data in social user database 140 while the snapshot 155 is taken. During the freeze time data written to the social user database 140 by processes other than the processes performed by the dumper 145 are cached until the snapshot is finished.

The snapshot 155 in the snapshot database 150 allows time consuming processing of the data in the snapshot 155. This time consuming processing can be performed without the risk of the data in the snapshot changing during the processing. The snapshot database 150 can also be sold as an entire data set to third parties that wish to analyze the data in the social user database 140. For example, a company might wish to examine snapshots over a period of time to evaluate the effectiveness of an advertising campaign based on topics 132 found by the topic mining engine and the number of users 110 interested in that topic 132. In some embodiments, the dumper 145 can produce a snapshot of a specific subset of the social user database 140 and store the snapshot of the subset in the snapshot database 150.

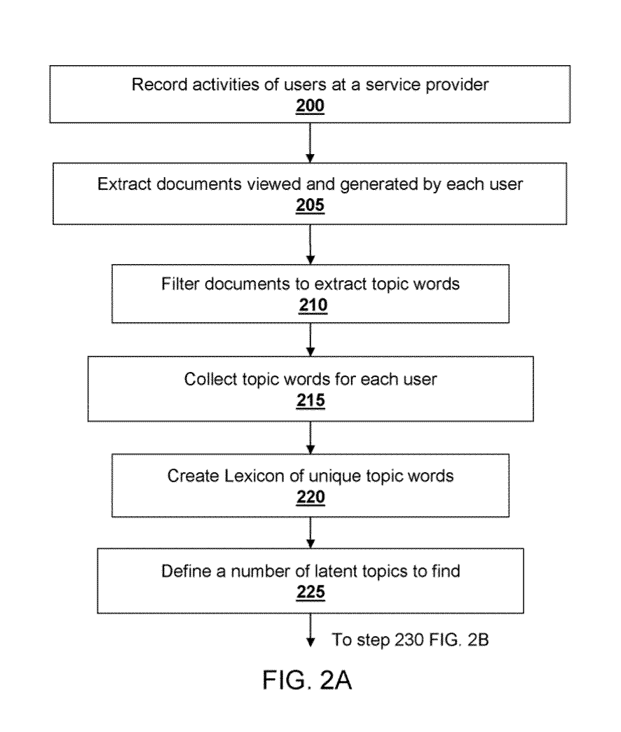

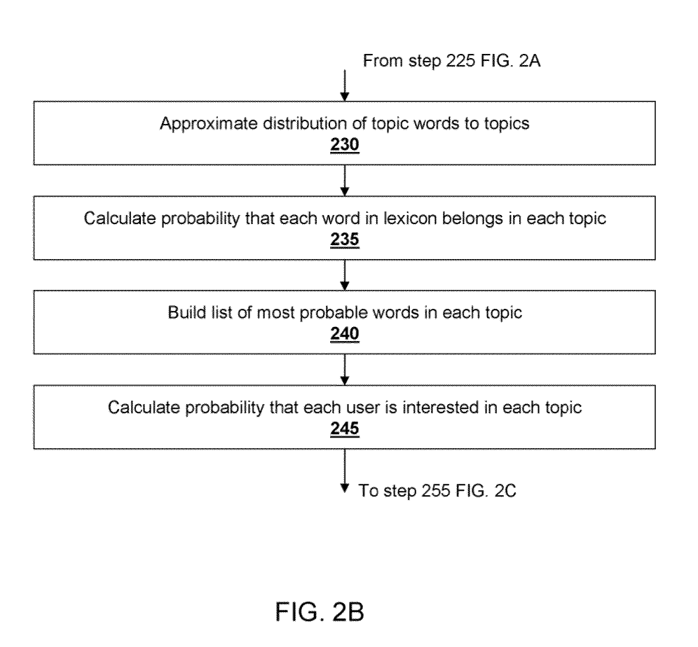

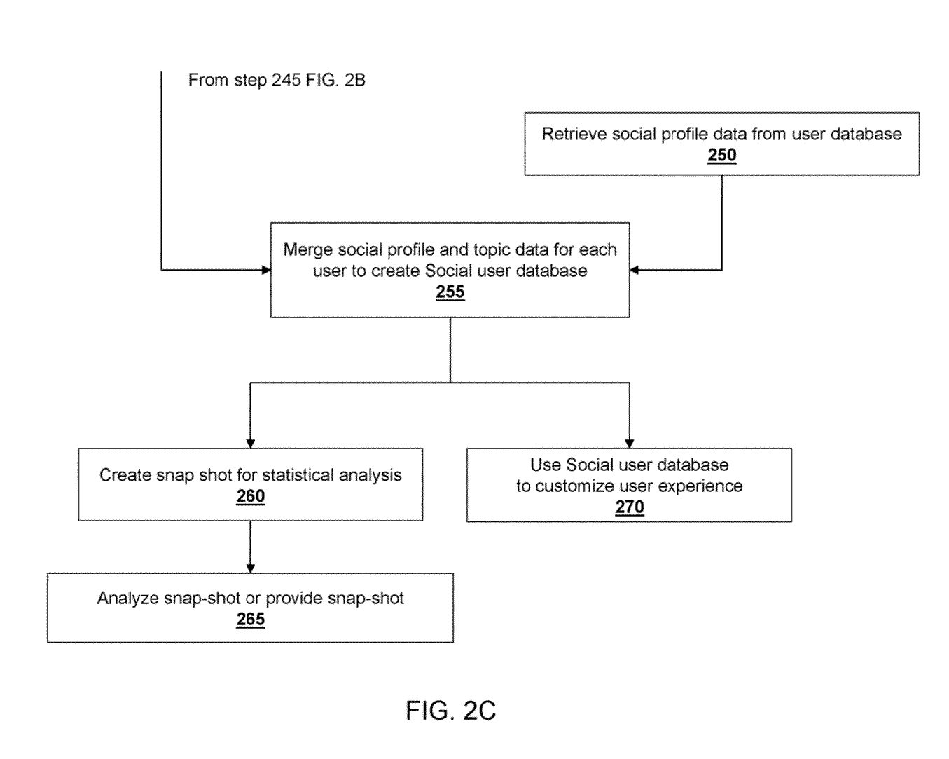

FIGS. 2A-2C illustrate a method of performing analysis to determine both explicit and underlying topics that users of a service provider are interested in. FIG. 2A illustrates steps 200-225.

The method begins at step 200. At step 200, an interaction collector, for example, interaction collector 105 records activities of users, for example, users 110 at a service provider, for example, service provider 168. The activities may be stored in a database, for example, interaction database 120. When a sufficient quantity of activities have been recorded the method proceeds to step 205.

At step 205, documents are extracted for each user from an interaction database. The interaction database contains information regarding the activity of each user at the service provider, for example, interaction database 120, as discussed above. The documents extracted for each user include, for example, e-mails, text messages, instant messages, sent or received by the user, web pages visited by the user, blogs compiled by the user, comments left on web pages by the user, or any other documents, files or images accessed by or created by the user compatible with embodiments of this disclosure. In some embodiments, the documents are concatenated into a single file for each user. In some embodiments, the documents are concatenated into a single file for all users, with the user indicated for each portion of the single file. In yet other embodiments, the extracted files remain separate with each file marked to indicate the user that the file came from. When all of the documents for each user have been extracted, the method proceeds to step 210.

At step 210, the documents for each user are passed through a text processor, for example, text processor 125 to extract topic words. In some embodiments, this is achieved by removing text unlikely to provide information regarding topics that the user is interested in. In some embodiments, the filtering step removes images, videos, and audio. In some embodiments, the filtering extracts text from images and videos based on image processing, and extracts words from audio based on speech to text software. Text and words extracted are added to the documents for the corresponding user and the original images, video, and audio are removed.

The filtering step 210 removes formatting characters, and formatting text such as HTML tags, XML tags, Rich Text formatting strings, and other formatting characters or strings that are unlikely to contain information regarding topics of interest to the user. The filtering then removes punctuation, and stop words such as and, the, a, prepositions, and other words unlikely to contain information regarding topics of interest to the user. In some embodiments, the stop words are not removed. In these embodiments, the stop words are ultimately classified in a topic that includes the stop words, because stop words tend to be used equally by all users. Removing the stop words has the advantage of reducing the size of data and the amount of processing to categorize words into topics. When the filtering is finished, the method proceeds to step 215.

At step 215, the remaining words in the documents for each user are extracted as topic words and the topic words are stored in a database corresponding to the user from which the topic words were extracted. In some embodiments, the database corresponding to the user may be a portion of a larger database, or lookup table. In some embodiments, a count is made of the number of times each word occurs in total for all of the users. Words that occur less than a predetermined threshold number of times are not stored in the database. Words that occur infrequently may not provide significant information regarding topics of interest to the users. If a particular word occurs more than once for each user, the word is stored the number of times it occurs. Thus, if the documents for user 1 contain the word “train” five times the word “train” is stored five times in the database for user 1. When the topic words have been extracted, the method proceeds to step 220.

At step 220, a lexicon is constructed of unique topic words for the users. Each of the topic words extracted for each of the users is examined. If the examined word is in the lexicon, the examined word is not added to the lexicon. If the examined word is not in the lexicon, the word is added to the lexicon. Thus, unlike the database for each user the lexicon contains one occurrence of each word independent of how many times the word is repeated in each user or across users. In some embodiments, the filtering of words that occur less than a predetermined threshold number of times may be performed while generating the lexicon. When the lexicon is complete, the method proceeds to step 225.

Step 225 is an optional step depending upon a particular algorithm used to assign topic words to topics. At step 225, the number of topics to be found is set. For a set of users, it is not known how many topics the set of users are interested in. However, many algorithms for assigning topic words to topics cannot determine the number of topics. Thus, those algorithms have a predetermined number of topics to be set. A reasonable estimate for the predetermined number of topics can be gauged from previous experience running topic word assignment algorithms and reviewing how well the topics are distinguished. For example, if the number of topics to be found is set too small then words from more than one topic will be assigned in the same topic. When the number of topics to be found is set the method proceeds to step 230.

FIG. 2B illustrates steps 230-245. At step 230, an algorithm is run that assigns the topic words for the users to topics based on correlations between the words used by the users. The topics are merely “numbered containers” in which to place words assumed to be assigned to the same topic. Running the algorithm a second time with the same topic words for the same user may cause the same words to be grouped together in a topic but they may not be in the same numbered topic containers. The precise topic for each of the topics can be understood by reviewing the words assigned to that topic once the algorithm is complete. When the assignment of topic words to topics is complete the method proceeds to step 235.

At step 235, the probability that each word in the lexicon belongs in each topic is calculated. In some embodiments, the calculation is performed by summing the number of times each topic word for each user is assigned to the topic. When the probability that each word in the lexicon belongs in each topic has been calculated, the method proceeds to step 240.

At step 240, for each topic, a list of the most probable topic words is compiled. In some embodiments, the list begins with the most probable topic word and ends with the least probable topic word. In some embodiments, all words with a probability greater than zero are included on the list. In some embodiments, words with a probability greater than a predetermined threshold are included on the list. In yet other embodiments, at most a predetermined number of the most probable words are included on the list. Any algorithm suitable for selecting a number of words to be included on the list of most probable words compatible with embodiments of this disclosure, is within the scope of this disclosure. When a list of most probable topic words for each topic is complete the method proceeds to step 245.

At step 245, the probability that each user is interested in a specific topic is calculated. In some embodiments, the calculation is performed by summing the number of times each topic word for the user is assigned to the topic. When the probability that each user is interested in a specific topic has been calculated, the method proceeds to step 255. The steps 215-245 correspond to topic mining as performed by, for example, topic mining engine 130. In some embodiments, the steps 215-245 are replaced by variants of the Latent Dirichlet Allocation (LDA) algorithm. In some embodiments, the steps 215-245 may be replaced by an equivalent Hierarchical Dirichlet Process, or Probabilistic Latent Semantic Analysis.

FIG. 2C illustrates steps 250-270. At step 250, a social profile for each user is obtained from a user database, for example, user database 115. The user database contains, for example, the name of each user, contact information for each user, authentication information for each user, the gender for each user, the citizenship of each user, the date of birth of each user, the career, profession, or job of each user and the interests explicitly declared by each user. The social profile for each user corresponds to information in the user database that indicates topics of interest of each user as well as any other information known about the user. For example, many websites allow users to select areas of interest, hobbies, favorite music, favorite books, most admired people etc. When the social profile for each user has been obtained, the method proceeds to step 255.

At step 255, the most probable words for each topic along with the probabilities of those words, and the probability that each user is interested in a specific topic are used to update a social user database, for example, social user database 140. Further, at step 255, the retrieved social profile for each user is used to update a social user database, for example, social user database 140. Step 255 may be performed at any time that the social profile for a user is changed because of a change in the user database, for example, user database 115. Further step 255 may be performed at any time that topic mining is executed. The social user database may be constantly updated each time there is a change in the user database or the interaction database. Alternatively, the changes can be cached for period of time, for example, one day and the update performed at the end of the period for all the cached changes. This can prevent the social user database being updated too frequently to reduce the system load. When all of the updates to the social user database are complete the method proceeds to step 260 and step 270.

At step 260, a snapshot of the social user database is taken. As discussed above the snapshot allows the data in the social user database to be frozen at a particular instant in time. This allows time-consuming analysis of the social user database to be performed without the data in the social user database changing as the analysis is performed. When the snapshot is complete the method proceeds to step 265. At step 265, the snapshot is provided for analysis of the data in the social user database. The snapshot may be provided to the service provider, or alternatively, provided to or sold to third parties so that the third parties can analyze the data. Before being provided or sold to third parties, the snapshot may be anonymized, or processed to remove information that could be used to identify the users.

At step 270, the social user database is used to customize the user experience. The customization may be performed by a service provider, for example, service provider 168. The customization may be in the form of customizing web pages requested by the user to reflect the interests of the user recorded in the social user database, for example, by providing links to additional information not specifically requested by the user, providing pop-ups of news or new information regarding topics of interest to the user. Alternatively, the user experience may be customized by sending e-mail or instant messages to the user for topics of interest to the user. The customization may also be in the form of advertisements inserted into web pages, e-mails, or instant messages sent to the user.

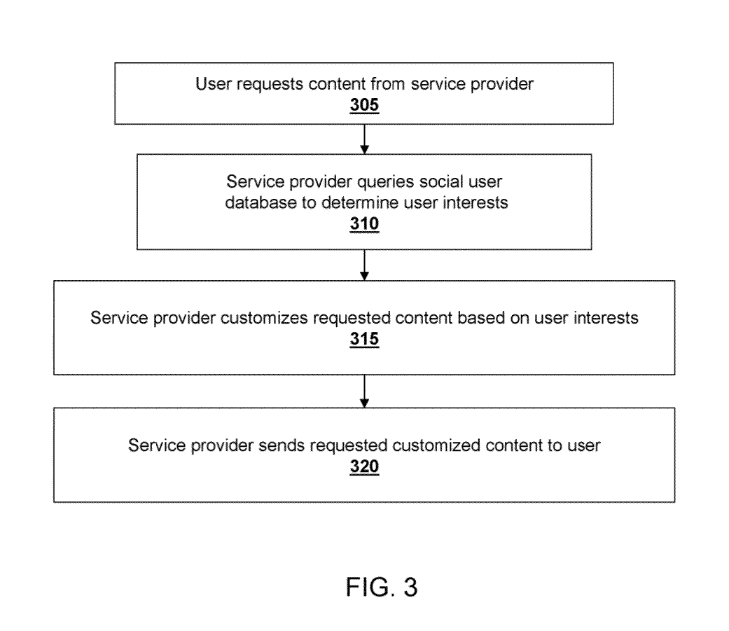

FIG. 3 illustrates a method of content customization as discussed above. The method begins at step 305. At step 305, the user requests content, for example, a webpage from a service provider, for example service provider 168. When the content has been requested, the method proceeds to step 310.

At step 310, the service provider queries the social user database, for example, social user database 140 to determine the interests of the user. In some embodiments, the query to the social user database is based on the content that the user has requested. For example, if the user requested a website corresponding to “cars,” the service provider may query the social user database specifically for interests corresponding to “cars.” Alternatively, the service provider may query the social user database for all interests of the user, in particular, the service provider may query all interests of the user if a request for specific interests returns no results. When the request is returned from the social user database, the method proceeds to step 315.

At step 315, the service provider customizes the content requested by the user based on the results of the query to the social user database. As indicated above, the customization may be in the form of customizing the web page requested by providing links to additional information, by providing pop-ups, and by sending e-mail or instant messages to the user. The customization may also be in the form of advertisements inserted into web pages, e-mails or instant messages received by the user based on the results of the query to the social user database. When customization of the web page is complete the method proceeds to step 320.

At step 320, the service provider sends the requested customized content to the user and the method terminates.

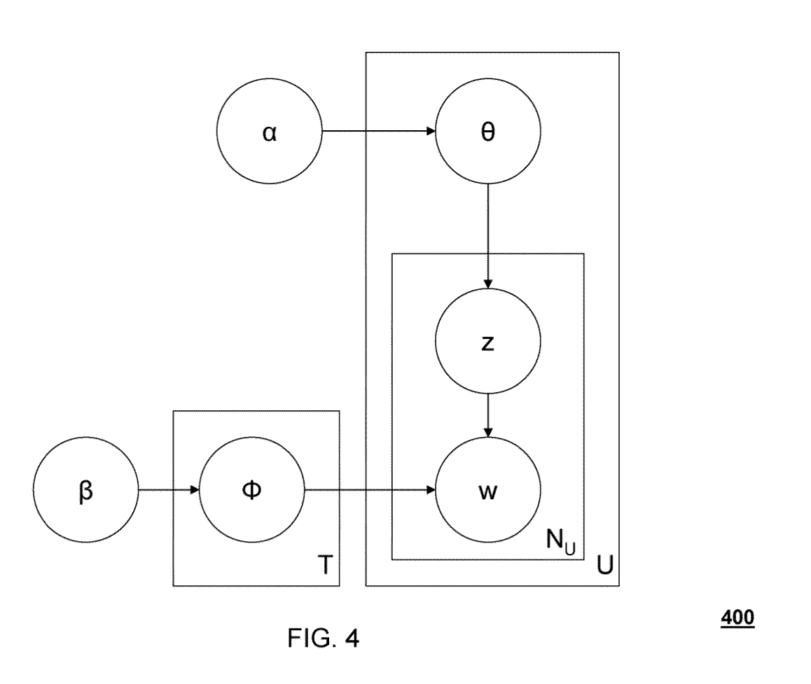

Returning to the topic mining engine 130 and steps 215-245 of FIGS. 1C, 2A, and 2B respectively, as noted above, the topic mining engine 130 and steps 215-245 can be replaced by variants of the LDA algorithm, a Hierarchical Dirichlet Process algorithm, or a Probabilistic Latent Semantic Analysis. The above techniques are based on topic models. FIG. 4 illustrates the topic model based on plate notation. The topic model in FIG. 4 is used in some embodiments to assign the topic words to topics, for example, in the topic mining engine 130 and steps 215-245. In FIG. 4, the per-user topic distribution is denoted as θ, each per-user topic distribution being drawn independently from a symmetric Dirichlet prior α, and the per-topic word distribution as φ, each being drawn from a symmetric Dirichlet prior β. T is the number of topics, U is the number of users, and N is the number of words for each user. Further, z is the topic for each word w.

In some embodiments, Gibbs sampling can be used to approximate the optimum way to assign the topic words to topics. Initially, topic words are assigned to topics in a random manner. From the assignments of the topic words, initial symmetric Dirichlet prior α, and β are constructed. The topic assignment is sampled from the conditional probability

$$P ( {z}_{i} = j \vert {w}_{i} = m , {z}_{- i} , {w}_{- i} ) ∝ \frac{{C}_{mj}^{WT} + β}{{\sum }_{{m}^{′}} {C}_{{m}^{′} j}^{WT} + V β} \frac{{C}_{uj}^{UT} + α}{{\sum }_{{j}^{′}} {C}_{{uj}^{′}}^{UT} + T α} \qquad Eqn . ( 1 )$$

where zᵢ=j represents the assignment of the iₜₕ word to topic j, wᵢ=m represents the observation that the iₜₕ word is the mₜₕ word in lexicon, z₋ᵢ represents all topic assignments not including the iₜₕ word. Furthermore, Cₘⱼ^{WT} is the number of times word m is assigned to topic j, not including the current instance, and Cᵤⱼ^{UT} is the number of times topic j is assigned to user not including the current instance. V is the total number of words in the Lexicon and T is the total number of topics.

The above sampling is performed for each topic word of each user. The topic assignments for the topic words are changed based on the conditional probability of Eqn. (1), and in some embodiments, a random number generator. The random number generator implementation works as follows. The value of P(zᵢ=j|wᵢ=m,z₋ᵢ, w₋ᵢ) for a particular word i and topic j is calculated. The random number generator produces a random number between, for example, 0 and 1. If the random number is greater than the value of P(zᵢ=j|wᵢ=m,z₋ᵢ, w₋ᵢ) then the word i is re-assigned to topic j. If the random number is less than P(zᵢ=j|wᵢ=m,z₋ᵢ, w₋ᵢ) then the word to topic assignment is not changed. The above is only an example of how to decide whether to reassign a particular word i to a topic j and any method compatible with embodiments of the disclosure may be applied to assign words to topics. For example, in some implementations of the Gibbs sampling algorithm, approximations and rounding errors can cause the calculated value of P(zᵢ=j|wᵢ=m,z₋ᵢ, w₋ᵢ) to be greater than 1. This is clearly an error and to address this error, if P(zᵢ=j|wᵢ=m,z₋ᵢ, w₋ᵢ) is greater than 1 the word i may always be assigned to topic j, independent of the random number generator. In some embodiments, random numbers are replaced by non-randomly produced numbers.

Once the above sampling has been performed for each topic word of each user, the new assignments are on average a better approximation of the assignments the words of the words to topics. The probability that each word in the lexicon belongs in each topic can be obtained from

$${φ}_{mj} = \frac{{C}_{mj}^{WT} + β}{{\sum }_{{m}^{′}} {C}_{{m}^{′} j}^{WT} + V β} , \qquad Eqn ( 2 )$$

and the probability that each user is interested in each topic can be obtained from

$${θ}_{uj} = \frac{{C}_{uj}^{UT} + α}{{\sum }_{{j}^{′}} {C}_{{uj}^{′}}^{UT} + T α} , \qquad Eqn ( 3 )$$

where φₘⱼ is the probability of using word m in topic j, θᵤⱼ is the probability of topic j for user u, V is the total number of words in the Lexicon, and T is the total number of topics.

Eqn (2) corresponds to one method of calculating the probability that each word in the lexicon belongs in each topic as described above in step 235. Eqn (3) corresponds to one method of calculating the probability that each user is interested in each topic as described above in step 245.

Base on Eqn (2) and (3) new priors are calculated and the sampling process is repeated until either a predetermined number of complete samplings is completed, or based on some measure, the assignment of topic words to topics has converged. In some embodiments, a predetermined “burn in” number of complete samplings is performed before attempting to assess if the Gibbs sampling has converged. In some embodiments, a convergence assessment is only made after each predetermined number of additional complete samplings, for example, after every 100 complete samplings.

The initial assignments of topic words to topics and the Dirichlet priors α, β are important, as they are in effect the first approximation for the per-user topic distribution and the per-topic word distribution. In general, these distributions are randomly assigned. However, if previous data is available for assignments of words to topics and users to topics these previous distributions may be used as the prior distributions α, β. The previous distributions may be for the same set of users or for a different set of users. If previous data can be used for the prior distributions then, in general, the Gibbs sampling will converge more quickly than for randomly produced Dirichlet priors.

Random Dirichlet priors α, β have the advantage that the initial state for the Gibbs sampling is less likely to be inadvertently placed far from a good assignment of words. For example, animal topic words, may initially be assigned equally to two different topics. In this situation, it may take some time before one of the topics, by chance, gathers a sufficient number of the animal words to cause the remaining animal words to be assigned to that topic during further sampling.

In some embodiments, the Dirichlet priors α, β are obtained, by using another technique to approximate the assignments of topic words to topics, before applying the Gibbs sampling. Techniques that may be applied to the assignments before applying the Gibbs sampling include, for example, maximization estimation and simulated annealing. The reason for applying these techniques before applying the Gibbs sampling, is that maximization estimation and simulated annealing may initially converge more quickly than Gibbs sampling with the input Dirichlet priors, but after a number of iterations Gibbs sampling may converge more quickly than these initial techniques.

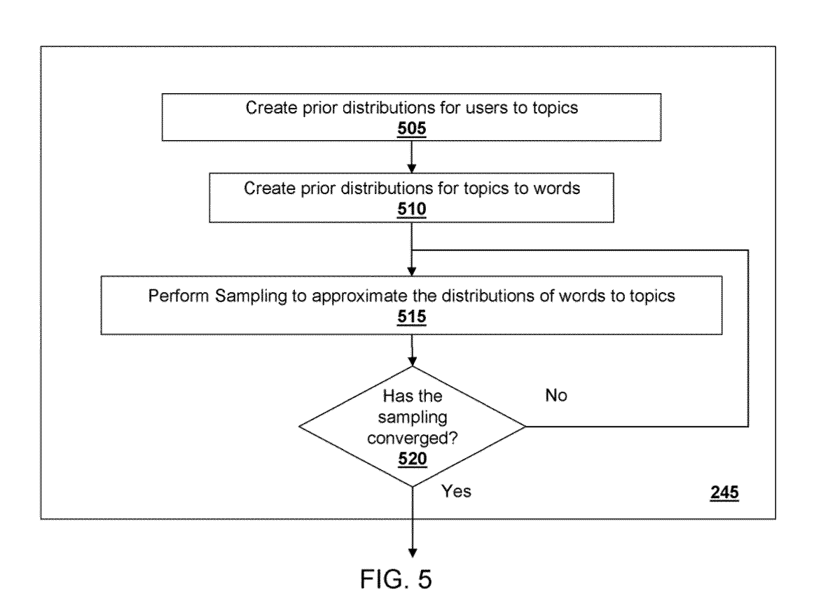

FIG. 5 illustrates a method for approximating the assignment of words to topics based on Gibbs sampling. The method begins at step 505.

At step 505, the prior distribution for users to topics is created. As noted above, the distribution may be created randomly, or be created based on a previous distribution generated based on previous data for either the same users or different users. When the prior distribution for users to topics has been created, the method proceeds to step 510.

At step 510, the prior distribution for topics to words is generated for each topic word of each user. As noted above, the distribution may be created randomly, or be created based on a previous distribution generated based on previous data for either the same users or different users. When the prior distribution for topic words to topics has been created, the method proceeds to step 515.

In some embodiments, the Gibbs sampling technique may be replaced by other techniques for assigning the topic words to topics. Other techniques include, for example, a Metropolis-Hastings algorithm, an expectation maximization algorithm, a gradient descent algorithm, conjugate gradient algorithm, or a Gauss-Newton method.

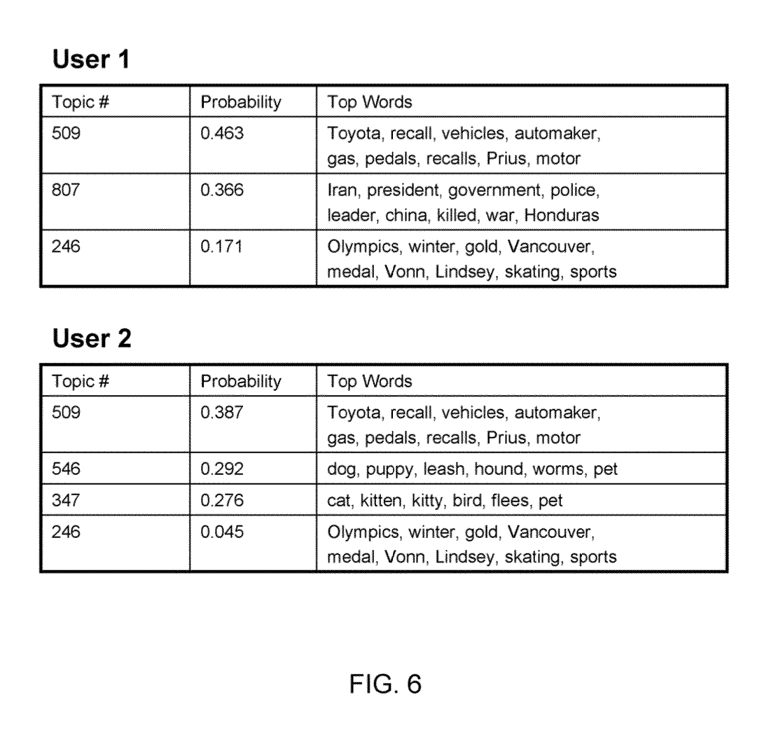

FIG. 6 illustrates an example of the resulting output from the above process for two users, user 1 and user 2, as tables. User 1 is interested in three topics, topics 509, 807, and 246. User 2 is interested in four topics, topics 509, 546, 347, and 246. The probability that each user is interested in each of these topics is shown in the second column. In the third column, the most probable words for each topic are shown. Based on the most probable words for each topic, it can be seen that topic 509 appears to be related to Toyota cars, topic 807 appears to be related to Iran, topic 246 appears to be related to the Olympics, topic 546 appears to be related to dogs, and topic 347 appears to be related to cats. The content of these tables for users is stored in the social user database, for example, social user database 140. Thus, the social user database contains the interest of the users and contains information indicating which words are likely to be found in the same topic. Any particular word may appear in multiple topics, for example, the word pet occurs in both topics 546 and 347.

The above social user database can be readily used, as discussed above, to improve user experience for the user of a service provider. The social user database allows the service provider to rapidly and accurately customize the content provided in accordance with the user's interests with great fidelity and accuracy. Further, analysis of the social user database allows the service provider to easily track trends in the interests of users and observe the emergence of new topics of interest as these new topics emerge from the combined activities of all the users at the service provider.

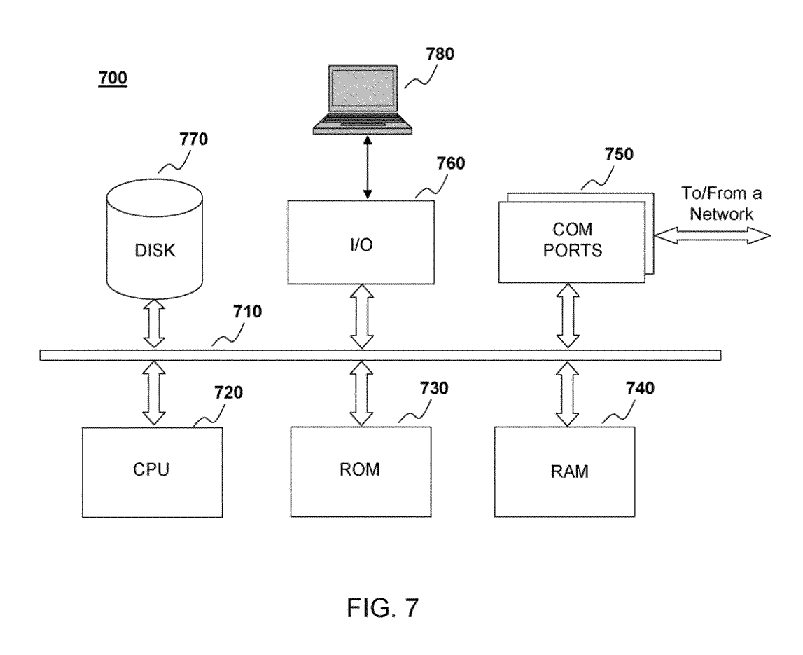

FIG. 7 depicts a general computer architecture on which the present teaching can be implemented and has a functional block diagram illustration of a computer hardware platform that includes user interface elements. The computer may be a general purpose computer or a special purpose computer. This computer 700 can be used to implement any components of the interest discovery system, as described herein. For example, interaction collector 105 that collects interactions of users with service providers, the text processor 125 that extracts topic words for users, and the topic mining engine 130, can all be implemented on a computer such as computer 700, via its hardware, software program, firmware, or a combination thereof. Although only one such computer is shown, for convenience, the computer functions relating to determining user interests may be implemented in a distributed fashion on a number of similar platforms, to distribute the processing load.

The computer 700, for example, includes COM ports 750 connected to and from a network connected thereto to facilitate data communications. The computer 700 also includes a central processing unit (CPU) 720, in the form of one or more processors, for executing program instructions. The exemplary computer platform includes an internal communication bus 710, program storage and data storage of different forms, e.g., disk 770, read only memory (ROM) 730, or random access memory (RAM) 740, for various data files to be processed and/or communicated by the computer, as well as possibly program instructions to be executed by the CPU. The computer 700 also includes an I/O component 760, supporting input/output flows between the computer and other components therein such as user interface elements 780. The computer 700 may also receive programming and data via network communications.

Hence, aspects of the methods and systems for interest discovery according to an embodiment, as outlined above, may be embodied in programming. Program aspects of the teaching may be thought of as “products” or “articles of manufacture” typically in the form of executable code and/or associated data that is carried on or embodied in a type of machine-readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, from a management server or host computer of the service provider operator or other user interest determining service provider into the hardware platform(s) of a computing environment or other system implementing a computing environment or similar functionalities in connection with determining user interests. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium, or physical transmission medium. Non-volatile storage media include, for example, optical or magnetic disks, such as any of the storage devices in any computer(s) or the like, which may be used to implement the interest discovery system or any of its components as shown in the drawings. Volatile storage media include dynamic memory, such as a main memory of such a computer platform. Tangible transmission media include coaxial cables, copper wire and fiber optics, including the wires that form a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will recognize that the present teachings are amenable to a variety of modifications and/or enhancements. For example, although the implementation of various components described above may be embodied in a hardware device, it can also be implemented as a software only solution—e.g., an installation on an existing server. In addition, the interest discovery system and its components as disclosed herein can be implemented as a firmware, firmware/software combination, firmware/hardware combination, or a hardware/firmware/software combination.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications, and variations that fall within the true scope of the present teachings.

1. A method implemented on a machine having at least one processor, storage, and a communication platform connected to a network for enhancing a service for a user comprising:
collecting one or more documents viewed by the user or words posted by the user;
identifying a list of topic words associated with the user based on words in the one or more documents and the words posted by the user;
assigning each of the topic words to at least one of a plurality of topics based on correlations between the topic words of the user and topic words from other users; and
estimating a set of interest topics for the user based on the topics assigned to the topic words of the user.

2. The method of claim 1, further comprising filtering the one or more documents for the user to remove at least one of images, graphics, scripting language, or formatting characters from the one or more documents before determining a list of topic words for the user.

3. The method of claim 1, further comprising:
building a lexicon of unique words contained in the list of topic words for the user and the other users; and
calculating a likelihood that each word in the lexicon is associated with each of the plurality of topics based on a number of times each of the topic words is assigned to a one of the plurality of topics.

4. The method of claim 1, further comprising providing the service to the user based on the set of interest topics associated with the user.

5. The method of claim 1, further comprising customizing content provided to the user based on the set of interest topics associated with the user.

6. The method of claim 3, further comprising merging the estimated set of interest topics for the user and the likelihood that each word in the lexicon is associated with each of the plurality of topics with declared interest data for the user from a first database in a second database.

7. The method of claim 6, further comprising at least one of making a snapshot of the second database or customizing web pages for the user based on the data regarding the user in second database.

8. A method, implemented on a machine having at least one processor, storage, and a communication platform connected to a network for enhancing a service for a user, comprising the steps of:
receiving, via the communication platform, documents viewed or words posted by the user;
determining a list of topic words for the user based on words in the documents and words posted by the user;
calculating a likelihood that each user is interested in one of a plurality of topics based on correlations between the topic words in the list of the topic words for the user and topic words in lists of topic words for other users;
determining a list of unique words from the list of the topic words for the user and the topic words in lists of topic words for the other users; and
calculating a likelihood that each unique word belongs to each of the number of topics based on correlations between the topic words for the user and the topic words in lists of topic words for the other users.

9. The method of claim 8, further comprising:
receiving, via the communication platform, a request for topics of interest of the user, and
sending information regarding interests of the user based on the likelihood that each user is interested in one of a plurality of topics.

10. A machine-readable tangible and non-transitory medium having information recorded thereon, wherein the information, when read by a machine, causes the machine to perform a method of enhancing a service for a user comprising:
collecting, via a communication platform, documents viewed or words posted by the user;
determining a list of topic words for the user based on words in the documents viewed or words posted by the user;
assigning each of the topic words to at least one of a plurality of topics based on correlations between topic words of the user and topic words of other users; and
estimating a set of interest topics for the user based on the topics assigned to the topic words of the user.

11. The machine-readable tangible and non-transitory medium of claim 10, the method further comprising providing the service to the user based on the set of interest topics associated with the user.

12. The machine-readable tangible and non-transitory medium of claim 10, the method further comprising:
receiving, via the communication platform, a request for topics of interest of the user; and
sending information regarding interests of the user based on the estimated set of interest topics for the user.

13. A system for enhancing a service for a user comprising:
a server that delivers the service to the user;
a first database coupled to the server that stores preferences or declared interests of the user;
a second database coupled to the server that stores information regarding documents viewed by or words posted by the user;
a topic mining engine that estimates an interest topic of the user based on correlations between a use by the user of topic words in the documents viewed by or posted the user and a use of the topic words by other users; and
a third database that stores the interest topic of the user estimated by the topic mining engine, wherein the server delivers the service to the user based on data in the third database associated with the user.

14. The system of claim 13, further comprising:
a text processor coupled to the first database that extracts the topic words from the documents viewed by or posted by the user.

15. The system of claim 13, further comprising:
an updater, coupled to the topic mining engine and the user database that combines the interest topic of the user estimated by the topic mining engine with the declared interests of the users and stores the combined interests in the third database.

16. The system of claim 13, wherein the server is coupled to the third database, and the server is adapted to customize the service delivered to the users based on the combined interests stored in the third database.

17. The system of claim 13, further comprising a dumper coupled to the third database that is adapted to create a snapshot of the third database and adapted to store the snapshot in a fourth database.

18. The system of claim 13, wherein the topic mining engine is adapted to build a lexicon of unique words used in the documents viewed by or words posted by the user.

19. The system of claim 18, wherein
the topic mining engine is further adapted to calculate a likelihood that each unique word in the lexicon is associated with each of the number of topics; and
the third database further stores the likelihood that each unique word in the lexicon is associated with each of the number of topics.

20. The system of claim 19, wherein the topic mining engine is adapted to assign each topic word to one of a plurality of topics including the interest topic, and calculate the likelihood of the interest topic of the user based on a number of the topic words for the user assigned to the interest topic and a likelihood that each unique word in the lexicon is associated with the interest topic based on a number of times each topic word is assigned to the interest topic.
